(19) United States
(12) Patent Application Publication
(10) Pub. No.: US 2013/0314661 A1
(43) Pub. Date: Nov. 28, 2013

(54) Hinge Structure for Glasses

(71) Applicant: Alexandre Masse, Montreal (CA)

(72) Inventor: Alexandre Masse, Montreal (CA)

(21) Appl. No.: 13/983,438

(22) PCT Filed: Feb. 2, 2012
(86) PCT No.: PCT/CA2012/000107

§ 371 Date: Aug. 2, 2013

(30) Foreign Application Priority Data
Feb. 2, 2011 (CA) 2730810

(51) Int. Cl. G02C 5/22

(52) U.S. Cl. CPC G02C 5/2254
USPC 351/153

(57) ABSTRACT

A hinge structure for interconnecting the temples of glasses or spectacles to the frame thereof is disclosed. The hinge structure is made of resilient polymeric material such as elastomeric material. The hinge structure also defines a generally smooth inner surface and a generally corrugated or bellows-shaped outer surface. The elastically compressible alternating ridges and furrows of the corrugation bias the temples of the glasses toward each other, thereby securing the temples to the head of the wearer. Still, at least one of the furrows is further provided with an enlarged groove at the bottom thereof to reduce the tension of the temples on the head of the wearer.

### CROSS-REFERENCE TO RELATED APPLICATIONS

There are no cross-related applications.

### FIELD OF THE INVENTION

The present invention generally relates to glasses and spectacles and relates more particularly to hinge structures for glasses and spectacles.

### BACKGROUND OF THE INVENTION

It is known to provide flexible resilient hinges to link or connect the temples of glasses or spectacles to the front frame thereof. These flexible resilient hinges allow a hinged attachment of the temples to the frame, thus allowing the temples to be pivoted between an inward stored, or folded, position in which the temples extend generally parallel to and along the frame, and an operative, or unfolded, position in which the temples extend generally perpendicularly to and away from the frame to engage the wearer's head above his ears.

Flexible resilient hinges have the advantage of further allowing the temples to be pivoted outwardly away from the frame beyond their operative position without damaging the hinges. This is useful in cases where the temples are accidentally moved beyond their operative position, to prevent the hinges, the temples and/or the frame from being damaged.

However, though flexible resilient hinges have some advantages over typical mechanical hinges, flexible resilient hinges also have some shortcomings. For instance, in order for the glasses to firmly engage head of the wearer, typical flexible resilient hinges are configured to bias the temples toward each other and thus toward the head of the wearer when the temples are in operative position. However, the bias, of biasing force, caused by the flexible resilient hinges can generate uncomfortable pressure points on the head of the wearer, the more so when the glasses are worn over an extended period of time.

Hence, despite ongoing developments in the field of glasses and flexible resilient hinges therefor, there is still a need for a new and improved flexible resilient hinge which at least mitigates some of the shortcomings of prior art flexible resilient hinges.

### SUMMARY OF THE INVENTION

The principles of the present invention are generally embodied in a flexible and resilient elastomeric hinge for used with glasses, the hinge having an inner surface and a generally corrugated outer surface having alternating ridges and furrows, the bottom end of at least one of the furrows having an enlarged groove for relieving or reducing the tension or pressure generated by the temples on the head of the wearer.

Hinges in accordance with the principles of the present invention will still bias the temples toward each other and thus toward the head of the wearer, thereby maintaining the glasses in place when worn while making the glasses generally more comfortable to wear, at least with respect to the engagement between the temples and the head of the wearer.

A hinge in accordance with the principles of the present invention generally comprises a main hinge portion, a first protrusion extending at a first extremity of the hinge portion and configured to engage the frame of the glasses, and a second protrusion extending at a second extremity of the hinge portion and configured to engage one of the temples of the glasses.

The inner surface of the hinge portion, i.e. the surface facing the wearer when the glasses are worn, is generally smooth, while the outer surface, i.e. the surface facing away from the head of the wearer when the glasses are worn, is generally corrugated, or bellows-shaped, as indicated above.

The corrugated outer surface comprises alternating ridges and furrows. In accordance with the principles of the present invention, at least one of the furrows comprises, in its bottom, an enlarged groove. In a further preferred embodiment, this groove has preferably a curvature radius larger than the bottom portion of the other furrow.

The enlarged groove generally reduces the biasing force of the hinges and thus the tension or pressure generated by the temples on the head of the wearer.

The first and second protrusions are generally configured to be sliding inserted into complementary openings in the frame and temples of the glasses.

In accordance with an improvement, the first and second protrusions are generally T-shaped (i.e. having a T-shaped cross-section) and the upper ends of the T-shaped protrusions are generally round or curved in configuration. By being curved, the upper ends of the protrusions can be more easily inserted into the machined openings of the frame and temples.

In accordance with another improvement, the rigidity of the elastomeric material from which the hinge is made is so chosen such that thinner hinges are made of more rigid material than thicker hinges. In other words, the thinner the hinge, the more rigid the elastomeric material from which it is made.

This increased rigidity of the thinner hinge compensates for the fact that a thinner hinge comprises less material to provide the same biasing force as a thicker hinge.

Other and further aspects and advantages of the present invention will be obvious upon an understanding of the illustrative embodiments about to be described or will be indicated in the appended claims, and various advantages not referred to herein will occur to one skilled in the art upon employment of the invention in practice. The features of the present invention which are believed to be novel are set forth with particularity in the appended claims.

### BRIEF DESCRIPTION OF THE DRAWINGS

The above and other objects, features and advantages of the invention will become more readily apparent from the following description, reference being made to the accompanying drawings in which:

FIG. 1 is a perspective view of a pair of glasses comprising hinge structures in accordance with the principles of the present invention.

FIG. 2 is a perspective view of one of the hinge structures of FIG. 1, alone.

FIG. 3 is a top perspective view of the hinge of FIG. 2.

FIG. 4 is a top cross-sectional view of the hinge of FIG. 2.

FIG. 5 is a top view of a pair of glasses in an unfolded position.

FIG. 6 is a close-up view of one of the hinge shown in FIG. 5.

FIG. 7 is a top view of a pair of glasses where the temples are pivoted beyond their operative position.

FIG. 8 is a close-up view of one of the hinge shown in FIG. 7.

FIG. 9 is a close-up view of one of the hinge in a resting or folded position.

FIG. 10 is another close-up view of one of the hinge in a resting or folded position.

FIG. 11 is another close-up view of one of the hinge in a resting or folded position.

### DETAILED DESCRIPTION OF THE PREFERRED EMBODIMENT

A novel hinge structure for glasses will be described hereinafter. Although the invention is described in terms of specific illustrative embodiments, it is to be understood that the embodiments described herein are by way of example only and that the scope of the invention is not intended to be limited thereby.

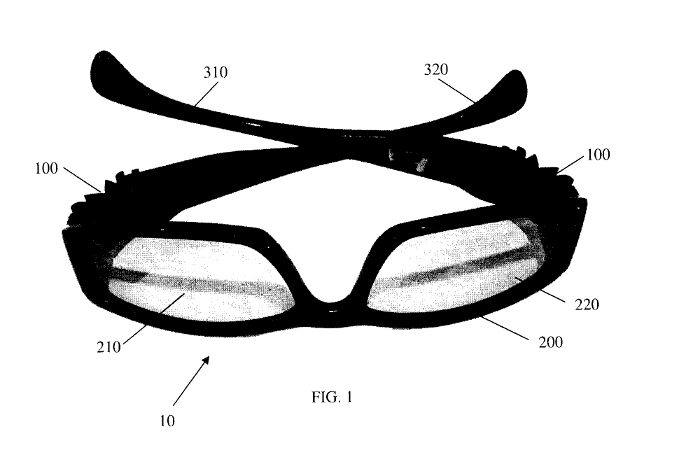

Referring first to FIG. 1, a pair of glasses 10 having two hinge structures 100 in accordance with the principles of the present invention is depicted. The glasses 10 are typical in that they comprise a front frame 200 configured to hold a pair of lens 210 and 220, and two temples 310 and 320 respectively connected to the sides of the frame 200 via the hinge structures 100.

As both hinge structures 100 are mirror image of each other, only one will be described hereinafter.

The hinge structure 100 is made of flexible and resilient elastomeric material such as thermoplastic elastomers (TPE), sometimes referred to as thermoplastic rubbers. In a preferred embodiment, the hinge 100 is made from the product sold as MEGOL®. MEGOL® family of TPE compounds is based on SEBS (Styrene-Ethylene-Butadiene-Styrene). It is characterised by excellent elastomeric properties, good UV and ozone resistance, easy colourability, a wide range of service temperatures, and is available in hardnesses from 10° Shore A to 60° Shore D. They are particularly suitable for co-moulding applications to PP and PE. By varying the proportions of the co-moulding product (for example PP and PE) the characteristics of the hinge are modified (ex: to modify the hardness). The resiliency of the elastomeric material generally provides the bias or biasing force necessary to secure the temples 310 and 320 of the glasses 10 to the head of the wearer.

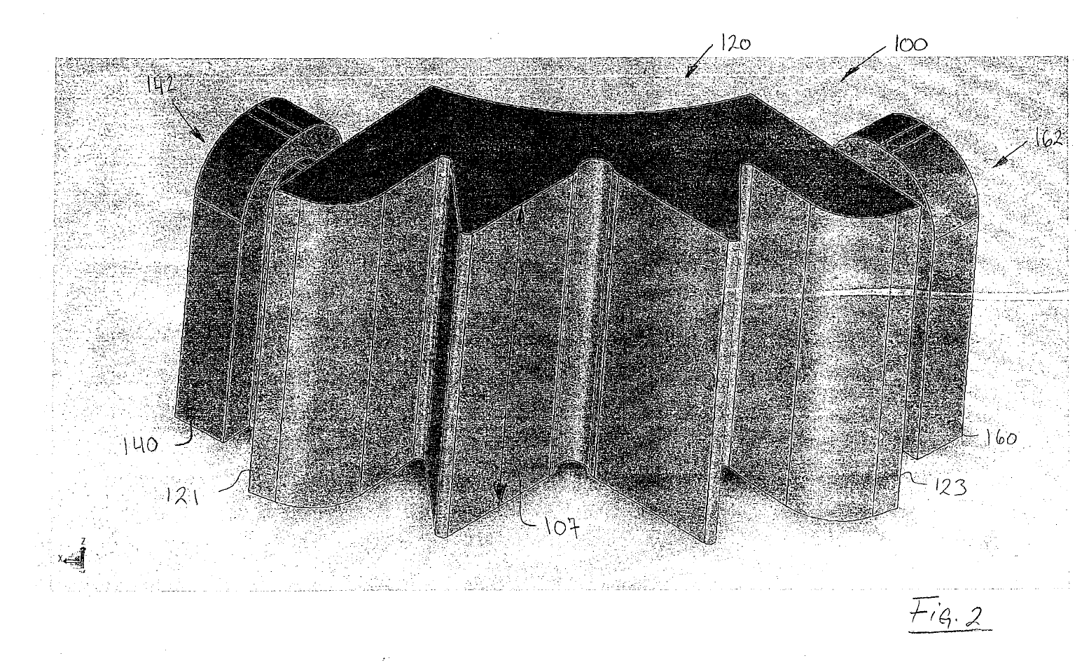

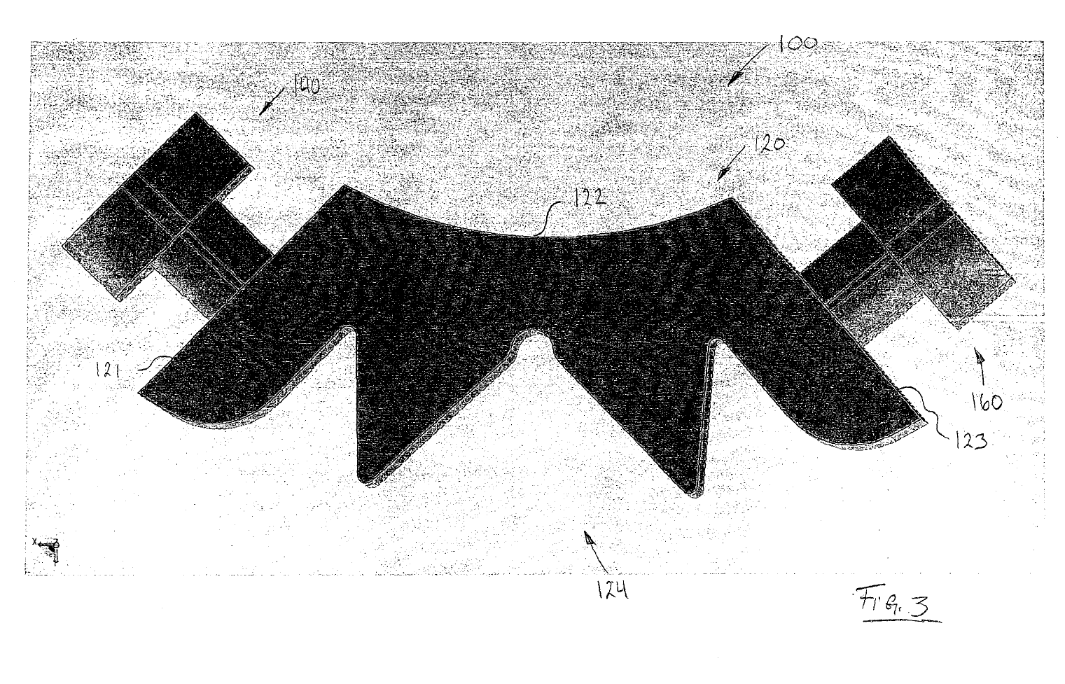

Referring now to FIG. 2-4, the hinge structure 100 generally comprises a central or main hinge portion 120 and two end protrusions 140 and 160 extending respectively at the first extremity 121 and at the second extremity 123 of the hinge portion 120.

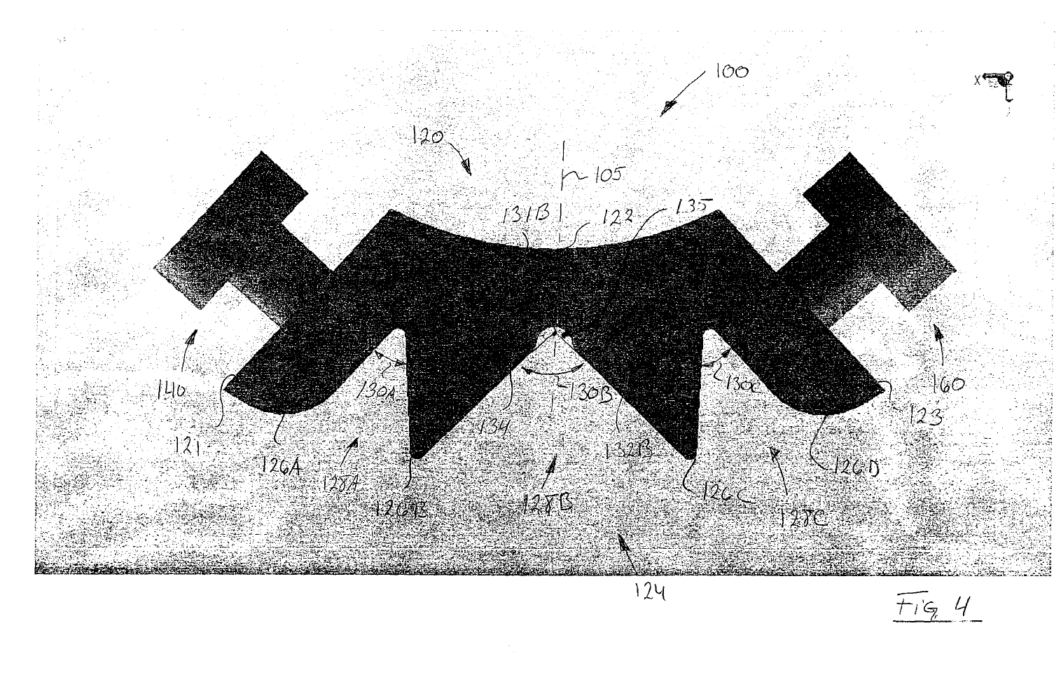

As best shown in FIG. 4, the protrusions 140 and 160 generally define a T-shaped cross-section.

The hinge portion 120 comprises an inner surface 122 and an outer surface 124. The inner surface 122 generally faces toward the head of the wearer while the outer surface 124 generally faces away from the head of the wearer when the glasses 10 are worn.

In the present embodiment, the inner surface 122 is relatively smooth while the outer surface 124 is substantially corrugated or bellows-shaped. In that sense, the outer surface 124 typically displays a series of alternating ridges 126 and furrows 128.

In the present embodiment, there are four ridges 126a, 126b, 126c and 126d, and three furrows 128a, 128b and 128c. However, the number of ridges 126 and furrows 128 could vary depending, for instance, on the size (e.g. length, thickness, etc.) of the hinge structure 100, and/or on the properties of the material of the hinge structure 100 or simply to modify the look of the glasses. A hinge structure in accordance with the principles of the present invention is not limited to four ridges and three furrows.

In addition, the exact shape and configuration of each of the ridges 126 need not be identical.

As further shown in FIG. 4, in the present embodiment, the opening angle 130b of the central furrow 128b is wider than the opening angle 130a and 130c of the other two furrows 128a and 128c. The larger distance between the two sides of the central furrow provides higher movement amplitude and a higher flexibility. In addition, and importantly, the central furrow 128b is provided, in its bottom 132b, with an enlarged groove 134.

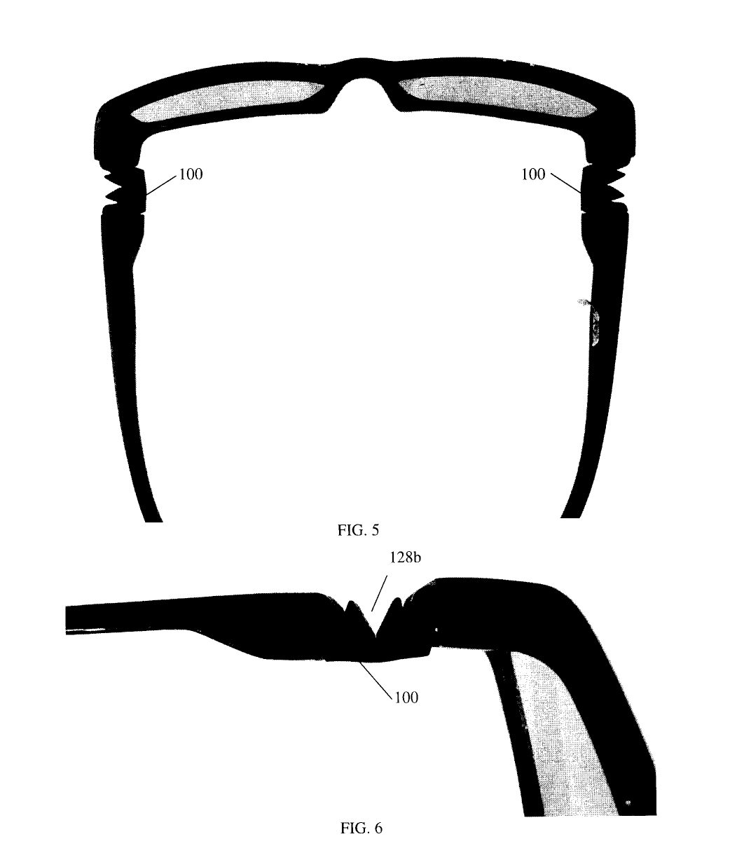

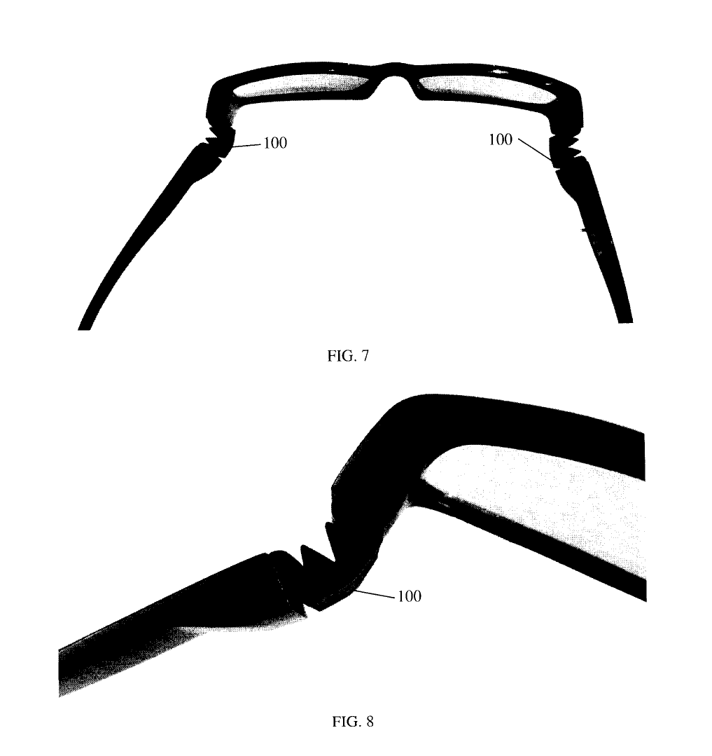

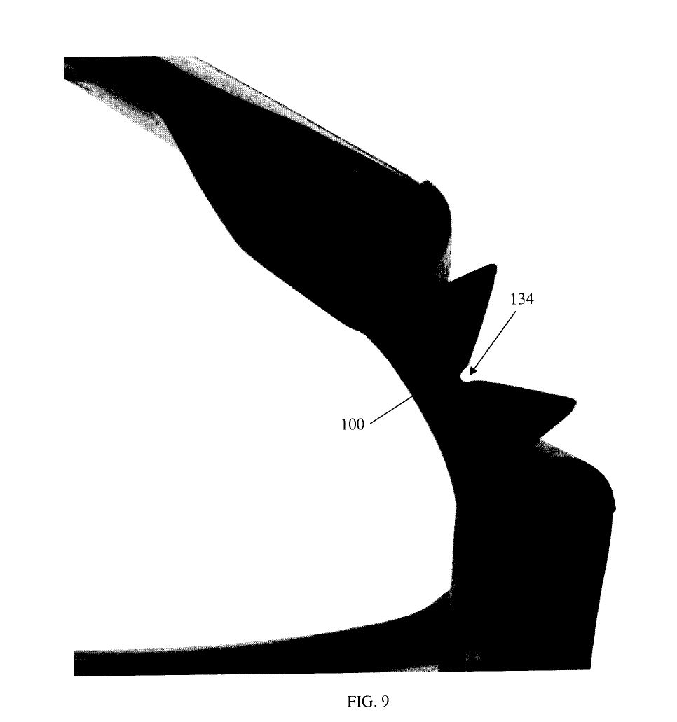

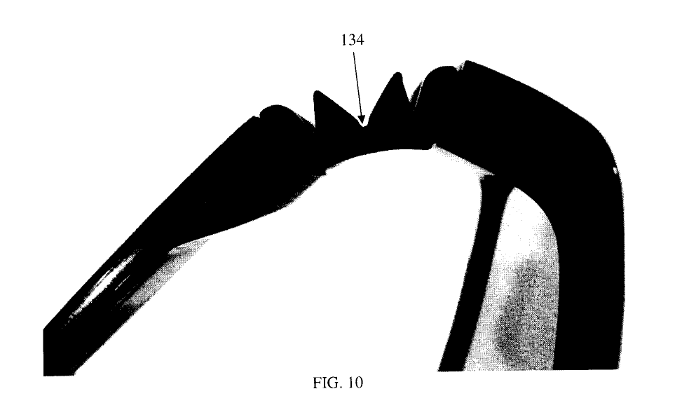

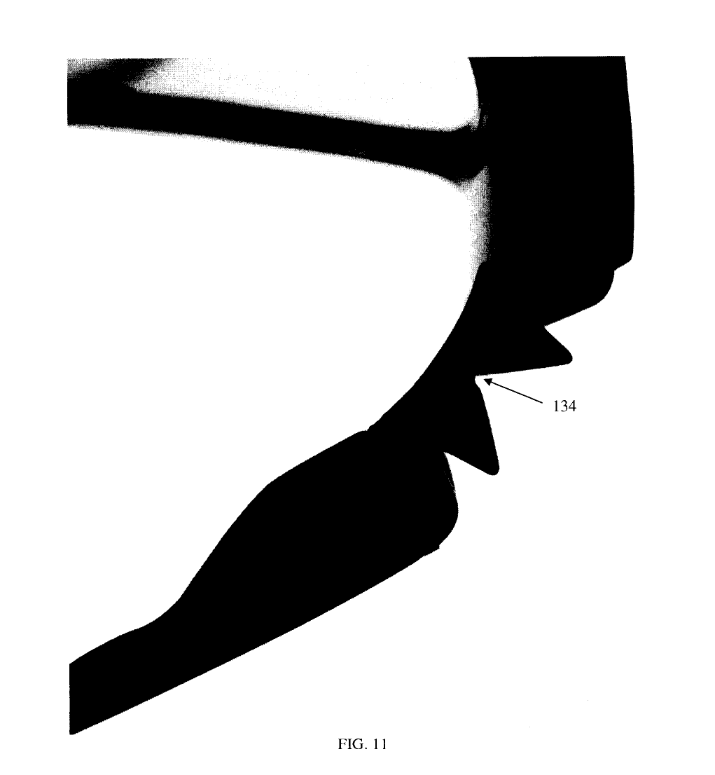

As it can be seen in FIGS. 5 and 6, when the temples are approximately perpendicular to the frame 200, the groove 134 is compressed and the central furrow 128b is not completely compressed, i.e. the surfaces forming the furrow 128b are not in contact. Consequently, the temples can still be opened further as shown in FIGS. 7 and 8, in this position, the surfaces forming the furrow 128b are closer.

As best illustrated in FIG. 4, the surface 135 of the groove 134 is deeper then the apex 131b of the opening angle 130b of the central furrow 128b.

In the present embodiment, the groove 134 has a generally semi-circular or circular cross-section as best shown in FIG. 4. However, in other embodiments, the shape of the groove 134 could be different. It is however preferable to have a generally round-shaped groove 134 to prevent premature cracking of the hinge structure 100. Tests have been made with hinges having the same shape as the present hinge but without a groove at the bottom portion of the wider furrow. Results show that hinges without a groove at the bottom portion of the central furrow are prone to cracking at the bottom portion of the wider furrow or where the protrusions are connected to the hinge.

As illustrated in FIGS. 2-4, the hinge structure 100 generally assumes a curved configuration when at rest. Consequently, when the glasses 10 are not worn, the temples 310 and 320 adopt automatically a folded or semi-folded configuration.

When the temples 310 and 320 are unfolded in their operative position, i.e. substantially perpendicular to the frame 200, the hinge portions 120 of the hinge structures 100 are straightened. When the hinge portion 120 is in a straight position, the outer surface 124 becomes in compression. As the hinge portion 120 tries to return to its resting position, the hinge structure 100 biases the temple 310 or 320 toward the head of the wearer.

However, as indicated above, the force applied by the temples 310 and 320 on the head is such that it prevents or decreases uncomfortable pressure points.

In accordance with the principles of the present invention, the groove 134 acts as a stress relief for the hinge portion 120. Indeed, the groove 134 allows the hinge portion 120 to be straightened or opened more easily as it reduces the level of compression of the outer surface 124, more particularly where the groove is located and where the protrusions are connected to the hinge. Consequently, the groove 134 reduces the biasing force of the hinge structure 100. By reducing the biasing force, the temples 310 and 320 engage the head of the wearer with less force, making the glasses 10 generally more comfortable to wear, at least relative to the temples' engagement with the head of the wearer

As shown in the figures, even though, in the present embodiment, the enlarged groove 134 is located at the bottom 132b of the central furrow 128b, the enlarged groove 134 could possibly be located at the bottom 132 of another furrow 128.

In addition, in a variant of the present embodiment, the hinge portion 120 could comprise more than one enlarged groove 134.

Referring particularly to FIG. 4, the skilled addressee will note that in the present embodiment, the hinge structure 100 is substantially symmetrical with respect to the axis 105. Though not necessary, this symmetry is preferable as it provides for a more aesthetically pleasing and more balanced hinge structure 100.

In the present embodiment of the hinge structure 100, the rigidity of the elastomeric material from which the structure 100 is made is selected according to the thickness 107 of the hinge portion 120 or according to a particular design characteristic.

In a further preferred embodiment, for a thinner version of the hinge structure 100, the rigidity will be greater than for a thicker version. This relation between the rigidity and the thickness of the hinge structure is to compensate for the difference in the amount of material.

Indeed, a thicker hinge portion 120 does not need to be as rigid as a thinner hinge portion 120 to generate the same amount of biasing force.

Referring now particularly to FIG. 2, the skilled addressee will notice that the upper portions 142 and 162 of the protrusions 140 and 160 are round or curved.

The curvature of the upper portions 142 and 162 of the protrusions 140 and 160 allows the protrusions 140 and 160 to be more easily inserted into the complementary openings in the frame 200 and the temple 310/320.

It is to be understood that when the openings in the frame 200 and in the temples 310 and 320 are machined after the molding thereof, some machining debris or asperities can remain stuck at the bottom of the openings and it is difficult and/or expensive to produce an opening that matches very closely the shape of the upper portions 142 and 162.

By having round or curved upper portion 142 and 162, the protrusions 140 and 160 of the present embodiment can be more easily inserted into the openings even if some machining debris remain in the openings.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A hinge structure, in accordance with the principles of the present invention, for used in combination with glasses.

2. A hinge structure for interconnecting a temple of glasses to a frame of the glasses, the hinge structure being made of resilient elastomeric material and comprising a main hinge portion, a first protrusion extending at a first extremity of the main hinge portion for connecting the hinge structure to the frame, and a second protrusion extending at a second extremity of the main hinge portion for connecting the hinge structure to the temple, the main hinge portion having an inner surface and a substantially corrugated outer surface, the outer surface defining alternating ridges and furrows, wherein at least one of the furrows further comprises, at a bottom thereof, and enlarged groove.

3. A hinge structure as claimed in claim 2, wherein the first protrusion defines a first curved upper portion, and wherein the second protrusion defines a second curved upper portion.

4. A hinge structure as claimed in claim 2, wherein the hinge portion has a thickness, and wherein a rigidity of the elastomeric material the hinge structure is chosen in accordance with the thickness.

5. Glasses comprising a frame, first and second temples, and first and second hinge structures respectively interconnecting the first and the second temples to the frame, each of the first and second hinge structures being made of resilient elastomeric material and comprising a main hinge portion, a first protrusion extending at a first extremity of the main hinge portion for connecting the hinge structure to the frame, and a second protrusion extending at a second extremity of the main hinge portion for connecting the hinge structure to one of the first and second temples, the main hinge portion having an inner surface and a substantially corrugated outer surface, the outer surface defining alternating ridges and furrows, wherein at least one of the furrows further comprises, at a bottom thereof, and enlarged groove.

6. Glasses as claimed in claim 5, wherein, for each of the hinge structures, the first protrusion defines a first curved upper portion, and the second protrusion defines a second curved upper portion.

7. Glasses as claimed in claim 5, wherein, for each of the hinge structures, the hinge portion has a thickness, and a rigidity of the elastomeric material the hinge structure is chosen in accordance with the thickness.
